(19) United States
(12) Patent Application Publication
(10) Pub. No.: US 2016/0358207 A1
(43) Pub. Date: Dec. 8, 2016

(54) SYSTEM AND METHOD FOR AGGREGATING AND ANALYZING USER SENTIMENT DATA

(71) Applicant: Emogi Technologies, Inc., New York, NY (US)

(72) Inventors: Travis Montaque, New York, NY (US); David A. Kalmar, Yardley, PA (US); Keisuke Inoue, Astoria, NY (US); Oleksandr Pasichnyk, Kiev (UA); Michael Ojemann, Concord, MA (US)

(21) Appl. No.: 15/173,225

(22) Filed: Jun. 3, 2016

Related U.S. Application Data
(60) Provisional application No. 62/171,220, filed on Jun. 4, 2015.

(51) Int. Cl. G06Q 30/02

(52) U.S. Cl. CPC G06Q 30/0245; G06Q 30/0254

(57) ABSTRACT

A system and method for aggregating and analyzing user sentiment data is provided. A method includes causing an advertisement to be displayed by a user device along with a plurality of non-alphanumeric sentiment indicators indicative of user sentiment. The method further includes receiving a user reaction to the advertisement, and transmitting an indication of the reaction to a server.

### CROSS-REFERENCE TO RELATED APPLICATION

This application claims the benefit or priority of U.S. Provisional Patent Application Ser. No. 62/171,220, filed Jun. 4, 2015, which is hereby incorporated by reference herein in its entirety.

### TECHNICAL FIELD

This disclosure relates to the field of online advertising and content publishing, and, more particularly, to aggregating and analyzing data related to user sentiment toward advertisements and published content.

### BACKGROUND

Advertisers and publishers often seek ways of evaluating content in terms of relevance, interest, and commercial applicability to their consumers. However, when a user fails to interact with an advertisement (by “skipping”) or an article, it is difficult to determine why some advertisements and articles outperform others. Moreover, content without any type of interaction or response cannot be optimized to generate revenue.

### BRIEF DESCRIPTION OF THE DRAWINGS

The present disclosure is illustrated by way of example, and not by way of limitation, in the figures of the accompanying drawings, in which:

FIG. 1 illustrates an example system architecture in accordance with embodiments of the disclosure;

FIG. 2 illustrates sentiment data flow from users/consumers to publishers, ad networks, and advertisers in accordance with the embodiments described herein;

FIG. 3 illustrates an exemplary user interface for collecting sentiment data related to an advertisement in accordance with embodiments of the disclosure;

FIG. 4 illustrates another exemplary user interface for collecting sentiment data related to an advertisement in accordance with embodiments of the disclosure;

FIG. 5 illustrates another exemplary user interface for collecting sentiment data related to an advertisement in accordance with embodiments of the disclosure;

FIG. 6 illustrates another exemplary user interface for collecting sentiment data related to an advertisement in accordance with embodiments of the disclosure;

FIG. 7 illustrates an exemplary user interface for collecting sentiment data related to non-advertisement content in accordance with embodiments of the disclosure;

FIG. 8 illustrates another exemplary user interface for collecting sentiment data related to non-advertisement content in accordance with embodiments of the disclosure;

FIG. 9A is a flow diagram illustrating a method for aggregating user sentiment data in accordance with an embodiment of the disclosure in accordance with embodiments of the disclosure;

FIG. 9B is a flow diagram illustrating another method for aggregating user sentiment data in accordance with an embodiment of the disclosure in accordance with embodiments of the disclosure; and

FIG. 10 is a block diagram illustrating an exemplary computer system for use in accordance with embodiments of the disclosure.

### DETAILED DESCRIPTION

Described herein are embodiments for aggregating and analyzing user sentiment data. Specifically, some embodiments are directed to methods for capturing an individual's reaction to various forms of content (such as advertisements) for the purpose of predicting future intent and action. Sentiment data may be obtained by eliciting responses from consumers through the use of graphical representations, such as non-alphanumeric sentiment indicators. An “emoji” is a type of non-alphanumeric sentiment indicator. Emojis are small digital images or icons that are used in electronic communication platforms to represent ideas, emotions, and sentiment. Emojis are most typically cartoonized facial expressions (e.g., smiles, frowns, etc.), but may be graphical representations other than facial expressions, such as hearts, food, thumbs up, thumbs down, etc.

In some embodiments, emojis may be used as surrogates for an underlying numeric scale. Emojis may be used to create a scale, which may not be bounded in terms of an upper value or a lower value, and may be presented for display in an ordered fashion that such that each emoji in the sequence represents an increasing/decreasing value based on the scale. Emojis may be used, for example, to represent one of three levels of measurement: ordinal, interval, or ratio. As an example, each emoji presented to and selectable by a user may be associated with a numerical values used for quantifying the user's sentiment (e.g., 5 emojis each representing an integer value between 1 and 10, with 1 representing strong dislike and 10 representing strong like).

In other embodiments, emojis do not necessarily have one-to-one associations with numerical values. For example, emojis may be used to gauge a user's sentiment in a non-numerical fashion (e.g., a user selection of a lightbulb emoji may indicate that the user found an article to be informative, a user selection of a garbage can emoji may indicate that the user found the article to be uninformative, etc.).

In some embodiments, a user may be presented with various emojis when viewing, for example, an advertisement. The user may select an emoji that best represents his/her sentiment towards the advertisement. Sentiment data may then be aggregated (e.g., by an analysis server) and analyzed in order to derive emotional or cognitive measures. As used herein, the term “sentiment” is not limited to a user's response (e.g., “makes me mad” or “makes me excited”) or cognitive responses (e.g., relevance of the content to the user, purchase interest/intent, importance, differentiation, memorability, etc.); sentiment may also be inclusive of, but not limited to, the emotional states presented in the works of Paul Ekman, Rachael Jack, Batja Mesquita, Robert Plutchik, James Russell, and Silvan Tompkins. For a comprehensive review of this work, see Russell, J. A., Culture and the categorization of emotions, Psychological Bulletin, 110, 426-50 (1991). Sentiment data may be numerical (e.g., a value indicating like or dislike) or non-numerical in nature (e.g., an indicator that the user is not interested in content, that the user intends to purchase an advertised item, etc.).

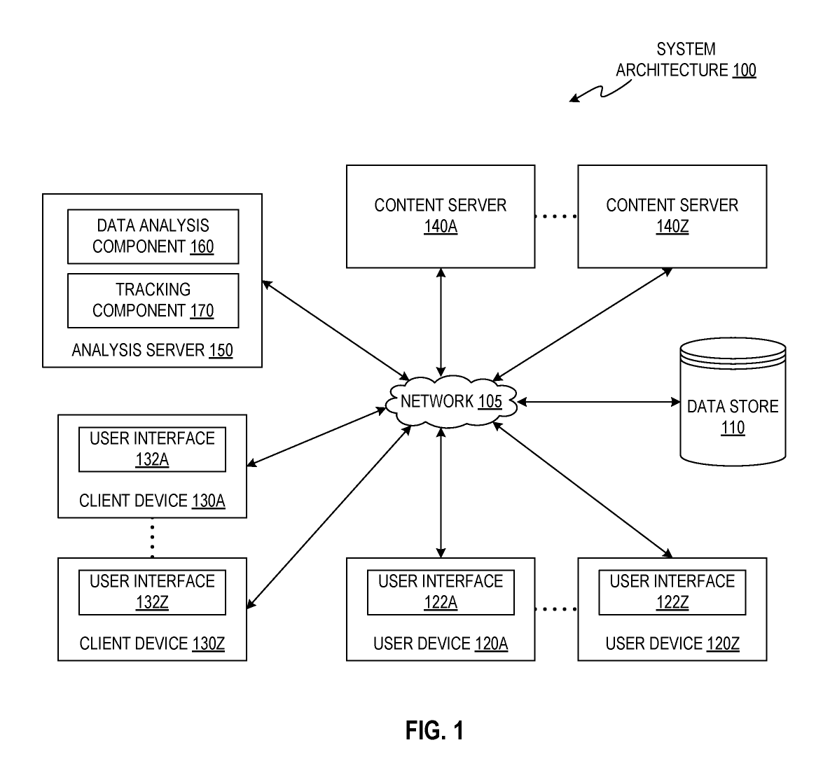

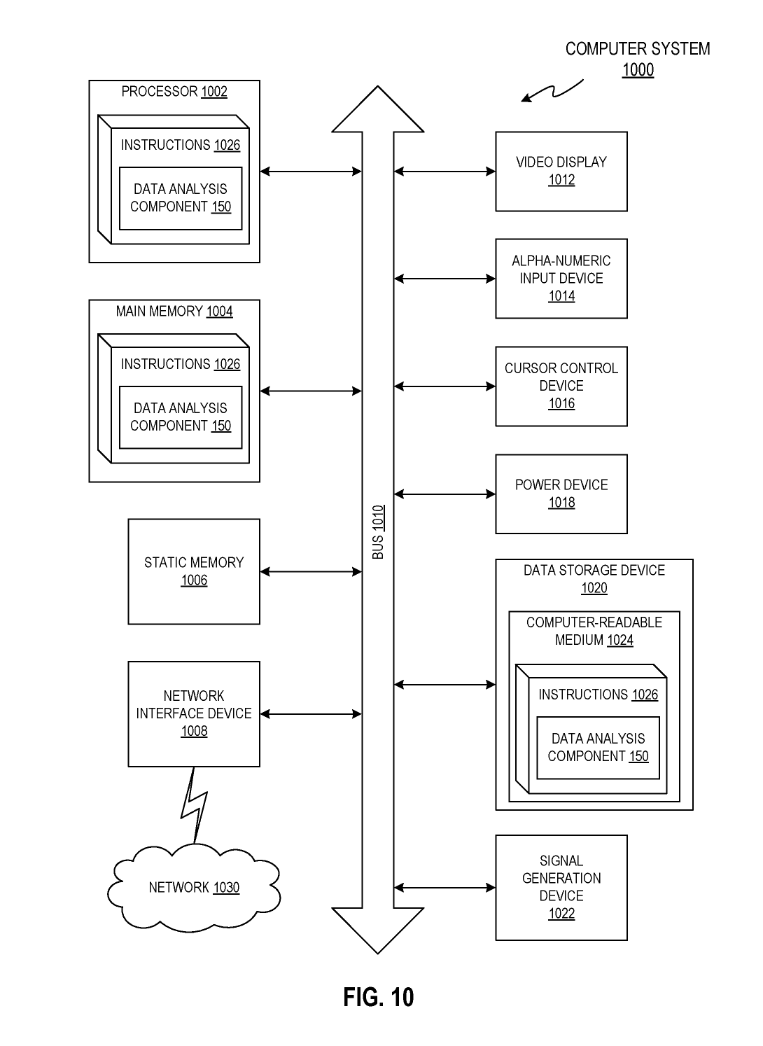

FIG. 1 illustrates an example system architecture 100, in accordance with an embodiment of the disclosure. The system architecture 100 includes a data store 110, user devices 120A-120Z, client devices 130A-130Z, content servers 140A-140Z, and an analysis server 150, with each device of the system architecture 100 being communicatively coupled via a network 105. One or more of the devices of the system architecture 100 may be implemented using computer system 1000, described below with respect to FIG. 10.

In one embodiment, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although the network 105 is depicted as a single network, the network 105 may include one or more networks operating as stand-alone networks or in cooperation with each other. The network 105 may utilize one or more protocols of one or more devices to which they are communicatively coupled. The network 105 may translate to or from other protocols to one or more protocols of network devices.

In one embodiment, the data store 110 may be a memory (e.g., random access memory), a cache, a drive (e.g., a hard drive), a flash drive, a database system, or another type of component or device capable of storing data. The data store 110 may also include multiple storage components (e.g., multiple drives or multiple databases) that may also span multiple computing devices (e.g., multiple server computers). In some embodiments, the data store 110 may be cloud-based. One or more of the devices of system architecture 100 may utilize their own storage and/or the data store 110 to store public and private data, and the data store 110 may be configured to provide secure storage for private data. In some embodiments, the data store 110 for data back-up or archival purposes.

The user devices 120A-120Z may each include computing devices such as personal computers (PCs), laptops, mobile phones, smart phones, tablet computers, netbook computers, etc. An individual user may be associated with (e.g., own and/or use) one or more of the user devices 120A-120Z. The user devices 120A-120Z may each be owned and utilized by different users at different locations. As used herein, a “user” is an individual who is the recipient of content from a content source (e.g., content servers 140A-140Z), and from whom sentiment data is collected. However, other embodiments of the disclosure encompass a “user” being an entity controlled by a set of users. For example, a set of individual users federated as a community in a company or government organization may be considered a “user”.

The user devices 120A-120Z may each implement user interfaces 122A-122Z, respectively. Each of the user interfaces 122A-122Z may allow a user of the respective user device 120A-120Z to send/receive information to/from each other, one or more of the client devices 130A-130Z, the data store 110, one or more of the content servers 140A-140Z, and the analysis server 150. For example, one or more of the user interfaces 122A-122Z may be a web browser interface that can access, retrieve, present, and/or navigate content (e.g., web pages such as Hyper Text Markup Language (HTML) pages) provided by the analysis server 150. As another example, one or more of the user interfaces 122A-122Z may be a messaging platform (e.g., an application through which user send text-based messages and other content). In one embodiment, one or more of the user interfaces 122A-122Z may be a standalone application (e.g., a mobile “app”, etc.), that allows a user of a respective user device 120A-120Z to send/receive information to/from each other, the data store 110, one or more of the content servers 140A-140Z, and the analysis server 140.

The client devices 130A-130Z may each include computing devices such as personal computers (PCs), laptops, mobile phones, smart phones, tablet computers, netbook computers, etc. The client devices 130A-130Z may each be owned and utilized by different individuals (“clients”). As used herein, a “client” may be a content publisher, advertiser, or other entity that has an interest in obtaining and analyzing user sentiment data from multiple users (e.g., user of user devices 120A-120Z). Each of the client devices 130A-130Z may allow a client to send/receive information to/from one or more of the client devices 130A-130Z, the data store 110, one or more of the content servers 140A-140Z, and the analysis server 150. For example, one or more of the user interfaces 122A-122Z may be a web browser interface that can access, retrieve, present, and/or navigate content (e.g., web pages such as Hyper Text Markup Language (HTML) pages) provided by the analysis server 150. As another example, one or more of the user interfaces 122A-122Z may be a messaging platform (e.g., an application through which text-based messages and other content are exchanged). In one embodiment, one or more of the user interfaces 122A-122Z may be a standalone application (e.g., a mobile “app”, etc.), that allows a user of a respective user device 120A-120Z to send/receive information to/from each other, the data store 110, one or more of the content servers 140A-140Z, and the analysis server 140 Like the user devices 120A-120Z, the client devices 130A-130Z may each implement user interfaces 132A-132Z, respectively, which may allow for sentiment data visualization and analysis. For example, the client devices 130A-130Z may receive sentiment data in raw form and or in processed form from the analysis server 150, and may visualize the data using their respective user interfaces 132A-132Z.

In one embodiment, the content servers 140A-140Z may each be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components from which content items and metadata may be retrieved/aggregated. In some embodiments, one or more of the content servers 140A-140Z may be a server utilized by any of the user devices 120A-120Z, the client devices 130A-130Z, or the analysis server 150 to retrieve/access content (e.g., an advertisement) or information pertaining to content (e.g., metadata).

In some embodiments, the content servers 140A-140Z may serve as sources of content, which may include advertisements, articles, product descriptions, user-generated content, etc., that can be provided to any of the devices of the system architecture 100. The content servers 140A-140Z may transmit content (e.g., video advertisements, audio advertisements, images, etc.) to one or more of the user devices 120A-120Z. For example, an advertisement may be served to a user device (e.g., the user device 120A) at an appropriate time while a user of the user device is navigating content received from a content source (e.g., one of the content servers 140A-140Z or another server). In response to a user selection of or interaction with the advertisement, additional information/content associated with the advertisement may be provided to the user device.

In one embodiment, the analysis server 150 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to evaluate user sentiment. The analysis server 150 includes a data analysis component 160 for analyzing and modeling user sentiment data, and a tracking component 170 for tracking user sentiment across various user devices 120A-120Z.

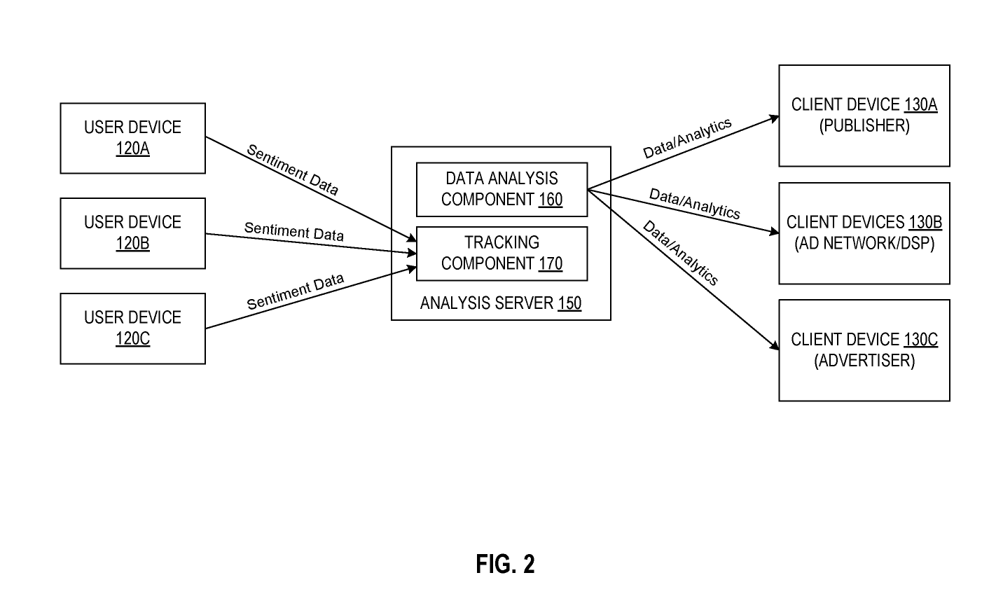

FIG. 2 illustrates sentiment data flow from users/consumers to publishers, ad networks, and advertisers in accordance with the embodiments described herein. For example, user devices 120A-120C, the analysis server 150, and client devices 130A-130C, as depicted in FIG. 1, are shown to illustrate the flow of data. Sentiment data is aggregated from the user devices 120A-120C by the tracking component 170 as the individual users react to various forms of content received at their respective devices. In some embodiments, the tracking component 170 queues the sentiment data, for example, using Kafka, Storm, or Secor/S3. In some embodiments, user reactions (i.e., sentiment data) is collected through a representational state transfer application program interface (REST API) and is queued for asynchronous processing. A distributed event-processing cluster may extract user-triggered events from the queue and apply natural language processing and/or machine learning algorithms to predict sentiment. In one embodiment, the user device 120A may execute a Javascript resource that collects the user interactions with displayed sentiment indicators, which are rendered for display by the user device 120A. Other embodiments may utilize windowed or windowless style widget integration or a REST API.

The data is processed by the data analysis component 160, and is then provided to the client devices 130A-130C for visualization. For example, the data analysis component 160 may derive emotional or cognitive measures and consumer psychographs based on the aggregated sentiment data and/or other data aggregated from the users. The client devices 130A-130C correspond to client devices of a content publisher, an ad network or demand-side platform (DSP), or an advertiser, respectively, to illustrate potential downstream users of the sentiment data.

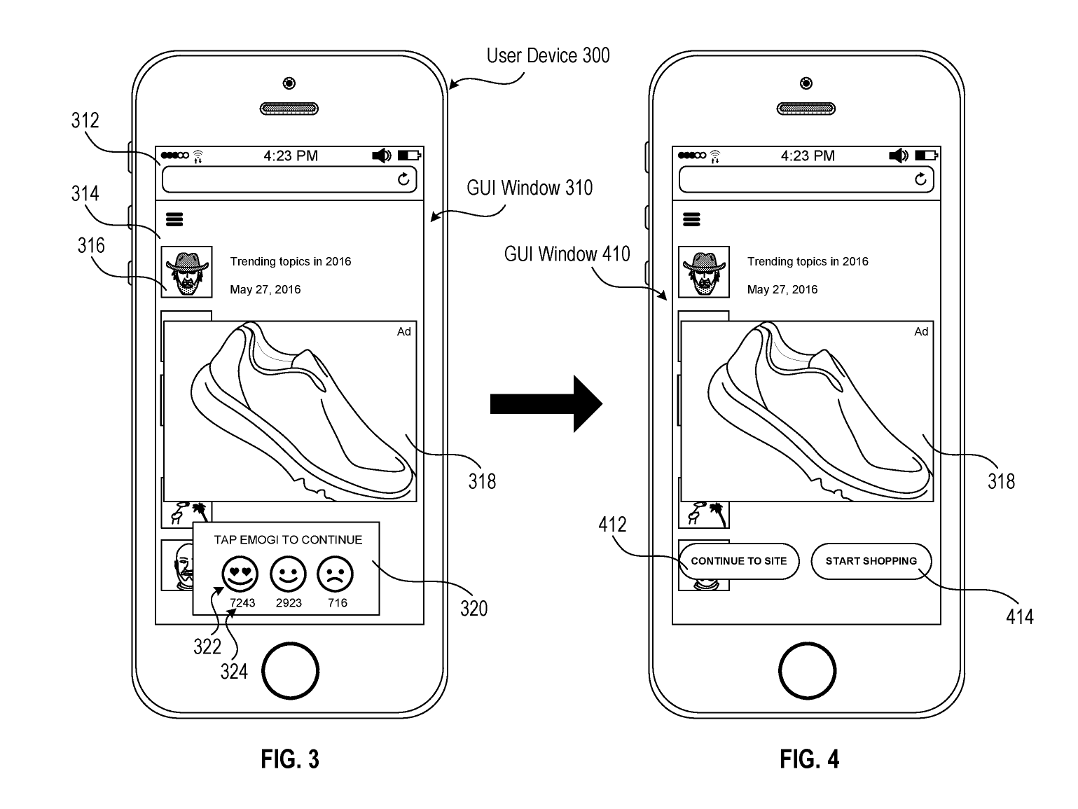

FIG. 3 illustrates a graphical user interface implemented by a user device 300 (e.g., which may correspond to one of the user devices 120A-120Z) for evaluating user sentiment for an advertisement in accordance with the embodiments described herein. The user device 300 presents, via a touch screen display, a graphical user interface (GUI) 310. The GUI window 310 includes a header region 312, which may display information relating to the user device 300, text boxes, and other options. The GUI window 310 also includes a main region 314 that may display various forms of content. The main region 314 is displays content 316, for example, which may correspond to content retrieved from a website. The user of the user device 300 may have specifically requested to view the content 316.

The GUI window 310 further depicts an advertisement 318, which appears in the main region 314 as an overlay on the content 316. In some embodiments, the advertisement 318 may appear as part of the content 316 (e.g., inline with the content 316) or adjacent to the content 316 in the main region 314 rather than as an overlay. The advertisement 318 may appear, for example, as the user is viewing the content 316 or in response to the user interacting with the content 316. The advertisement 318 may be presented as video, one or more images, audio, text, or a combination thereof. In some embodiments, a user selection of the advertisement 318 (e.g., tapping with a finger, pressing an enter key, selecting with a mouse cursor, etc.) causes the GUI window 310 to display content associated with the advertisement 318 (e.g., if the main region 314 is displaying a website, the user may be redirected to a website associated with the advertised product or service). In some embodiments, a user selection of a region outside of the advertisement 318 may cause the advertisement 318 to be dismissed.

In some embodiments, an emoji selection region 320 is presented for display. The emoji selection region 320 may be presented simultaneously with the advertisement 318, after the advertisement 318 has been presented for a pre-defined amount of time (e.g., after 3 seconds, after 5 seconds, etc.), or after the advertisement 318 has ended (e.g., if the advertisement 318 is a video). The emoji selection region 320 contains selectable emojis, such as emoji 322. In some embodiments, the emoji selection region 320 includes a counter 324 that indicates to the user of the user device 300 how many other users have selected emoji 322 when viewing the same or similar advertisement with their respective devices.

Each emoji may be representative of user sentiment, and may be tailored to a particular type of information that an advertiser seeks to obtain from the user. In some embodiments, selection of an emoji by the user may be utilized downstream to measure the user's cognitive and/or emotional sentiment towards the advertisement 318 or a brand associated with the advertisement 318. Such sentiment may include, but is not limited to, general sentiment toward what the user is viewing, relevancy of an advertisement, likelihood to purchase (e.g., based on awareness, familiarity, interest, etc.), likelihood to recommend, and engagement with respect to the advertised product/service. In some embodiments, one or more captions (e.g., a caption and a sub-caption) may be displayed in the emoji selection region 320 along with the emojis to elicit a particular type of user feedback. As an example, a caption may read “Please vote to close this ad”, which may be used to gauge user sentiment toward the advertisement 318 in general. As another example, a caption may read “How relevant is this ad?”, which may be used to gauge relevance of the advertisement 318 to the user. As another example, a caption may read “How likely are you to purchase this product?”, which may gauge purchase intent.

In some embodiments, if the advertisement 318 is a video advertisement, the emojis may be selectable after the video ends and remain selectable until the user selects one of the emojis. In some embodiments, one or more of the emojis may appear while the advertisement 318 is displayed. In some embodiments, the emojis may remain selectable for a pre-determined time (e.g., 3 seconds, 5 seconds, 10 seconds, etc.) after the video ends and may disappear automatically if one of the emojis is not selected within the pre-determined time. An analysis server (e.g., the analysis server 150) may receive an indication of the emoji selected by the user and store this information.

In some embodiments, the user may be restricted from returning to the content 316 until an emoji is selected. In some embodiments, in response to a user selection of the emoji 322, the GUI window 310 may take on the appearance of GUI window 410, as illustrated in FIG. 4, where the emoji selection region 320 is replaced by options 412 and 414. A selection of option 412 may cause the advertisement 318 to be dismissed. A selection of option 414 may cause additional content associated with the advertisement 318 to be displayed (e.g., the user is redirected to a webpage for a product/service associated with the advertisement 318).

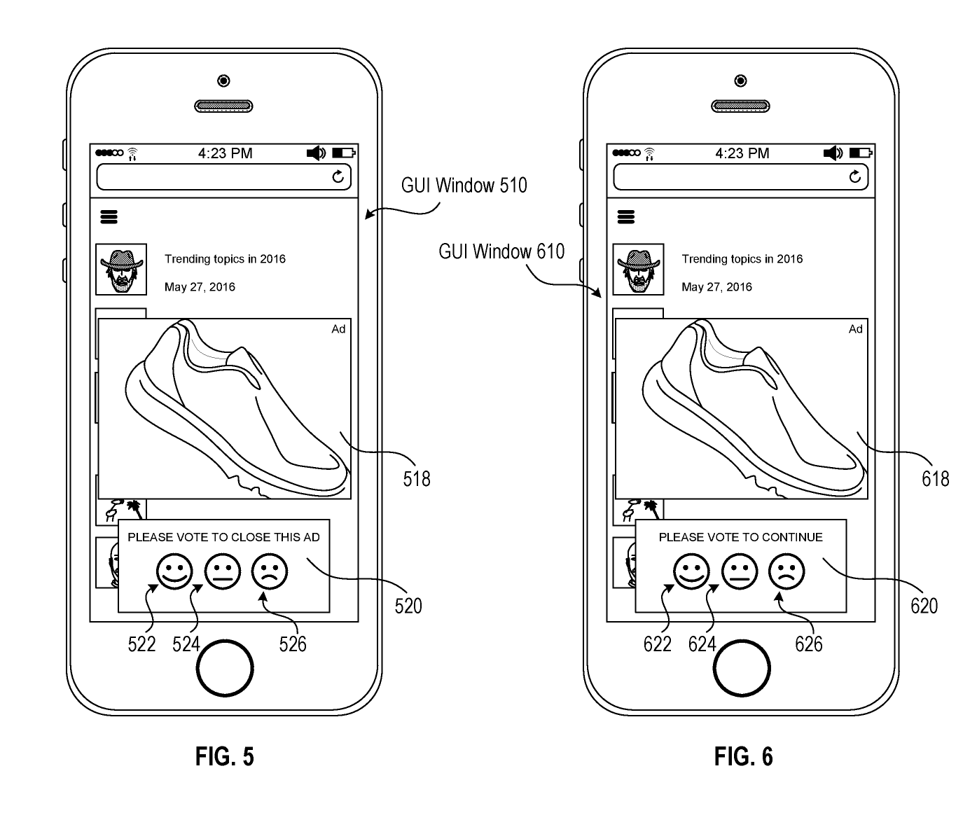

FIGS. 5 and 6 illustrate GUI windows 510 and 610, respectively, in accordance with other embodiments. For example, the GUI window 510 includes an advertisement 518 and an emoji selection region 520. The emoji selection region 520 includes a caption instructing the user to “Please vote to close this ad.” In response to a user selection of any of emojis 522, 524, or 526, the advertisement 518 is dismissed, while a user selection of the advertisement 518 causes content associated with the advertisement 518 to be displayed. In an alternative embodiment, the GUI window 610 includes an advertisement 618 and an emoji selection region 620. The emoji selection region 620 includes a caption instructing the user to “Please vote to continue.” In this embodiment, a selection of particular emojis may have different effects. For example, a selection of emoji 622, which represents the most positive sentiment of all of the displayed emojis, may result in content associated with the advertisement 518 to be displayed. A selection of emojis 624 or 626, which represent neutral and negative sentiment, respectively, may result in the advertisement 618 being dismissed.

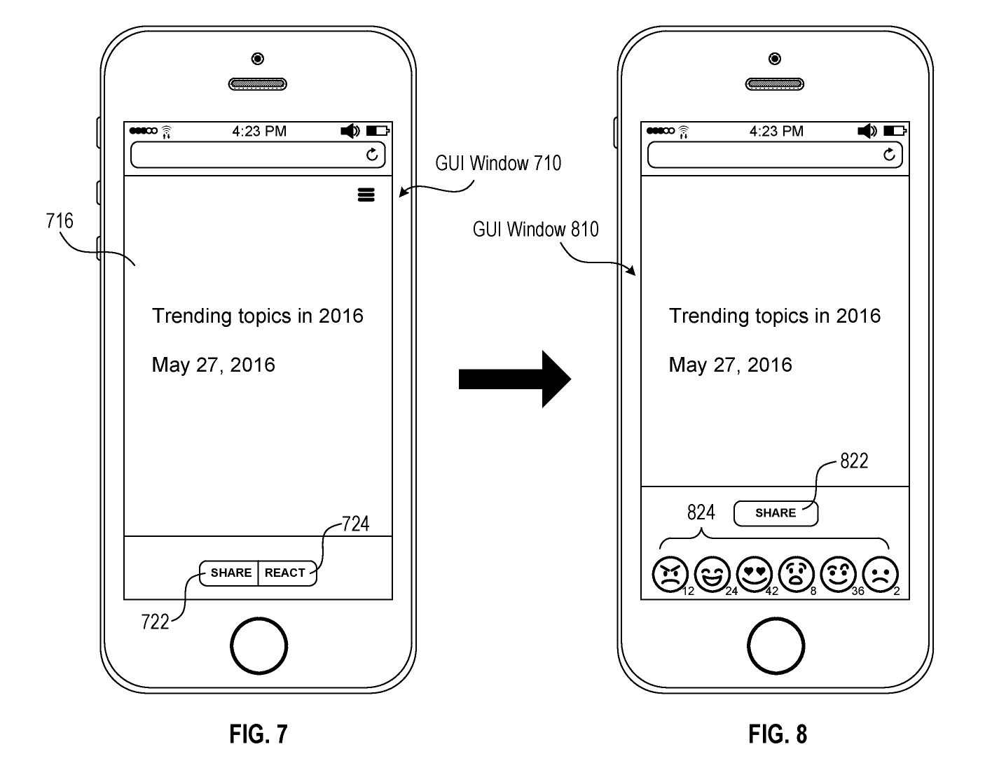

FIGS. 7 and 8 illustrate GUI windows 710 and 810, respectively, in accordance with embodiments for evaluating user sentiment of other types of content. The GUI window 710 includes content 716, which may be any type of content other than an advertisement (e.g., an article, a video, etc.). In some embodiments, the GUI window 710 includes share option 722 and react option 724. In response to a selection of the share option 722, the GUI window 710 may display additional selectable options that enable the user to share the content with other users (e.g., via a social media platform). In response to selecting the react option 724, the GUI window 710 may take the form of GUI window 810, which displays a share option 822 and emojis 824. The user may select one of the emojis 824 that match his/her sentiments toward the article. In some embodiments, numerical counters may be displayed next to each of the emojis 824, which indicate how many other users have selected that particular emoji. In some embodiments, the emojis 824 may be presented to the user without the user selecting the react option 724. For example, the emojis 824 may be displayed automatically (e.g., after a pre-determined amount of time that the user has spent viewing the article) or in response to another input (e.g., an audio cue from the user, the user scrolling through toward the end of the article, etc.).

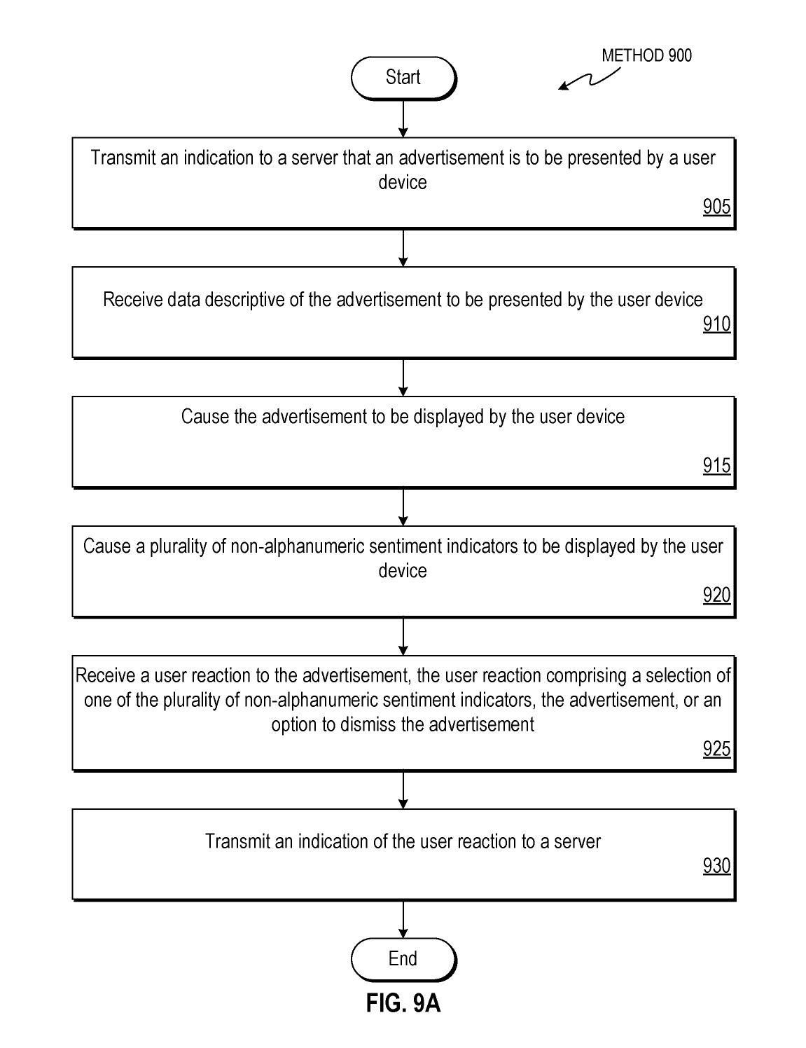

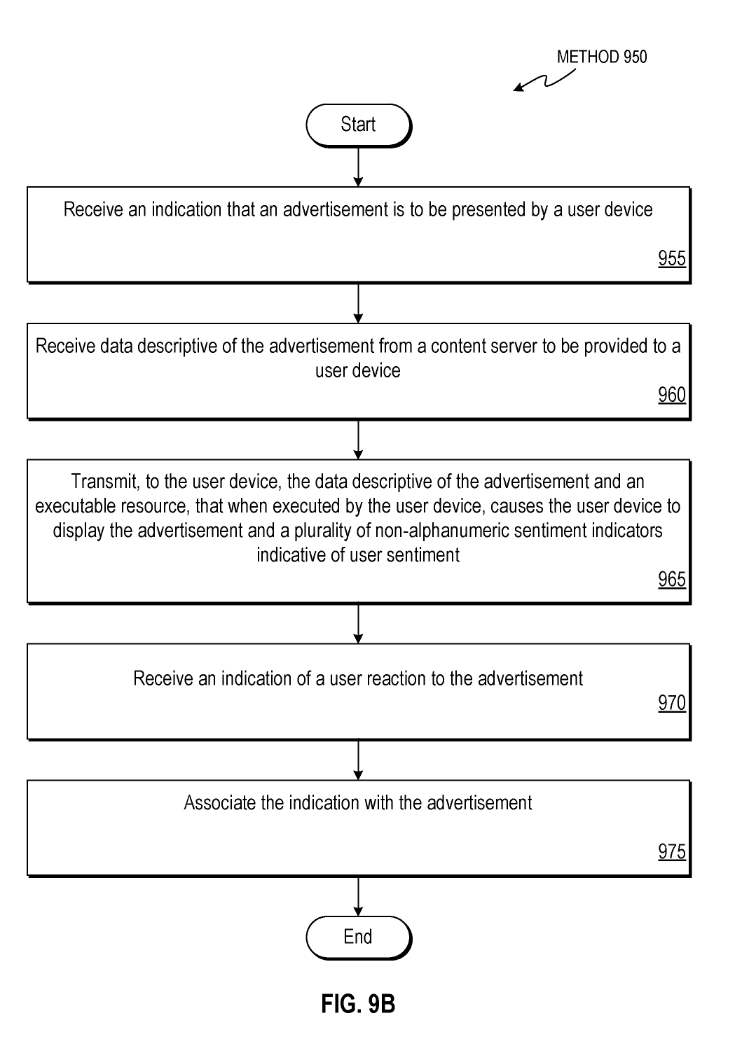

FIGS. 9A and 9B are flow diagrams illustrating a method 900 and a method 950, respectively, for aggregating user sentiment data in accordance with an embodiment of the disclosure. The methods 900 and 950 may be performed by processing logic that includes hardware (e.g., circuitry, dedicated logic, programmable logic, microcode, etc.), software (e.g., instructions run on a processing device to perform hardware simulation), or a combination thereof. In one embodiment, the method 900 is executed, for example, by a processing device of a user device (e.g., one of the user devices 120A-120Z implementing a respective user interface 122A-122Z). In one embodiment, the method 950 is executed, for example, by a processing device of a server (e.g., the analysis server 150).

Referring to FIG. 9A, the method 900 begins at block 905 when a processing device of a user device (e.g., one of the user devices 120A-120Z) transmits to a server (e.g., the analysis server 150) an indication that an advertisement is to be presented by the user device. At block 910, the processing device receives data descriptive of the advertisement to be presented by the user device. The data may be received, for example, from one of the content servers 140A-140Z. In some embodiments, the data is received from another source (e.g., the analysis server 150, the data store 110, etc.). In other embodiments, the data is associated with other types of content that are not related to an advertisement, such as an article, a video, a social media post, etc. In some embodiments, block 905 is performed before block 910, after block 910, or concurrently with block 910.

At block 915, the processing device causes the advertisement to be displayed by the user device (e.g., as illustrated in FIGS. 3-6). In some embodiments, the advertisement is a still image or a video (e.g., advertisement 318). In some embodiments, the advertisement is a video, an image, text, audio, or a combination thereof. The advertisement may be displayed in response to the user of the user device attempting to access specific content (e.g., content 316). For example, the user device may access a specific website. The website may require the user device to view the advertisement in response to accessing the website, which may be routed to the user device from one of several sources, including a content provider that hosts the website, a content server (e.g., one of the content servers 140A-140Z), or another server (e.g., the analysis server 150). In some embodiments, the advertisement may be displayed as an overlay over other content (e.g., advertisement 318), as part of (inline with) the other content, or adjacent to the other content. For example, when the user device displays content that the user is attempting to access, the content may be presented in a graphical user interface (e.g., the GUI window 310), and the advertisement may be overlaid on the content. In some embodiments, the advertisement appears a pre-determined time after the accessed content is presented (e.g., 3 seconds, 5 seconds, 10 seconds, etc.).

At block 920, the processing device causes a plurality of non-alphanumeric sentiment indicators (e.g., emojis) to be displayed by the user device. The non-alphanumeric sentiment indicators may be indicative of user sentiment (e.g., emojis 522, 524, and 526). The emojis may be pictographic representations of emotional or cognitive states (e.g., facial expressions in some embodiments). In some embodiments, the plurality of non-alphanumeric sentiment indicators are displayed for a pre-defined time duration, and may disappear after the time duration ends. For example, one or more of the plurality of non-alphanumeric sentiment indicators may disappear prior to the end of the advertisement (e.g., if the advertisement is a video). In some embodiments, one or more of the plurality of non-alphanumeric sentiment indicators may appear simultaneously with the advertisement, after the advertisement is displayed (e.g., 3 seconds, 5 seconds, etc. after the advertisement is displayed), or after the advertisement ends (e.g., if the advertisement is a video).

At block 925, the processing device receives a user reaction to the advertisement. The user reaction may comprise a selection of one of the plurality of non-alphanumeric sentiment indicators, the advertisement, or an option to dismiss the advertisement. In some embodiments, the user may select a non-alphanumeric sentiment indicator by tapping with a finger, selecting with a mouse cursor, or using any other suitable method. In some embodiments, a camera of the user device may capture an image of the user's face and map the user's expression to one of the non-alphanumeric sentiment indicators using an image processing algorithm. The graphical user interface may indicate the mapped non-alphanumeric sentiment indicators, and the user may have the option to confirm the selection in some embodiments.

In some embodiments, the processing device may determine that the user did not select one of the plurality of non-alphanumeric sentiment indicators, but instead selected (e.g., clicked on, tapped, etc.) the advertisement (e.g., which may register as a “click-through” event), or an option to dismiss the advertisement (e.g., by selecting a “close” button, clicking outside of the advertisement area, etc.).

At block 930, the processing device causes an indication of the user reaction to be transmitted to a server (e.g., the analysis server 150). In some embodiments, block 930 may be omitted. In one embodiment, additional options to be displayed in response to selection of a non-alphanumeric sentiment indicator (e.g., options 412 and 414). In one embodiment, selection of a non-alphanumeric sentiment indicator may cause the advertisement to be dismissed.

In some embodiments, if the user selected the advertisement or an option to dismiss the advertisement, the indication transmitted to the server may indicative of such a selection. For example, selecting the advertisement directly in lieu of selecting one of the non-alphanumeric sentiment indicators results in an indication of a click-through event to the server and that none of the non-alphanumeric sentiment indicators were selected by the user.

In one embodiment, if the selected non-alphanumeric sentiment indicator is representative of positive sentiment, the processing device may retrieve additional data associated with the advertisement rather than cause the additional options to be displayed. In another embodiment, if the non-alphanumeric sentiment indicator is representative of neutral or negative sentiment, the processing device may remove the advertisement from display.

Referring to FIG. 9B, the method 950 begins at block 955 when a processing device receives an indication that an advertisement is to be presented by a user device (e.g., one of the user devices 120A-120Z). In some embodiments, the indication is transmitted from the user device to the processing device directly.

At block 960, the processing device receives data descriptive of the advertisement from a content server (e.g., one of the content servers 140A-140Z). In other embodiments, the processing device receives an indication that the advertisement was sent or is being sent to the user device. In some embodiments, the processing device does not receive the data; rather, the data is transmitted directly to the user device.

At block 965, the processing device transmits, to the user device, the data descriptive of the advertisement and an executable resource. In some embodiments, the executable resource is a script. The executable resource may encode for a method to be performed by a user device (e.g., the method 900). In some embodiments, when the executable resource is executed by the user device, the user device may display a plurality of non-alphanumeric sentiment indicators. In some embodiments, the plurality of non-alphanumeric sentiment indicators is displayed together with the advertisement. In embodiments where the processing device does not receive the data descriptive of the advertisement, the processing device transmits the executable resource without transmitting the data descriptive of the advertisement.

At block 970, the processing device receives an indication of a user reaction to the advertisement. The user reaction may include a selection of one of the plurality of non-alphanumeric sentiment indicators, the advertisement, or an option to dismiss the advertisement. For example, upon selection, the indication is transmitted from the user device to the processing device.

At block 975, the processing device associates the indication with the advertisement. For example, the processing device may store, in a data structure, an identifier of the advertisement or a product/service associated with the advertisement, and sentiment data collected that in response to showing the advertisement (e.g., a selected non-alphanumeric sentiment indicator, a click-through event, etc.). The processing device may process the sentiment data, for example, to generate a sentiment score, to track sentiment over time, to generate consumer psychographics, etc. The sentiment data in raw or processed form may be transmitted to a client device for visualization purposes (e.g., one of the client devices 130A-130Z).

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture”, as used herein, is intended to encompass a computer program accessible from any computer-readable device or storage media.

Although embodiments of the disclosure were discussed in terms of evaluating consumer sentiment in response to advertisements, the embodiments may also be generally applied to any system in which an individual's sentiment may be used to provide feedback. Thus, embodiments of the disclosure are not limited to advertisements.

FIG. 10 illustrates a diagrammatic representation of a machine in the exemplary form of a computer system 1000 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a set-top box, a television (e.g., a “smart TV”), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 1000 may be utilized by or illustrative of any of the data store 110, one or more of the user devices 120A-120Z, one or more of the content servers 140A-140Z, and the analysis server 150.

The exemplary computer system 1000 includes a processing device (processor) 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage device 1020, which communicate with each other via a bus 1010.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1026 for performing the operations and steps discussed herein.

The computer system 1000 may further include a network interface device 1008. The computer system 1000 also may include a video display unit 1012 (e.g., a liquid crystal display (LCD), a cathode ray tube (CRT), or a touch screen), an alphanumeric input device 1014 (e.g., a keyboard), a cursor control device 1016 (e.g., a mouse), and a signal generation device 1022 (e.g., a speaker).

Power device 1018 may monitor a power level of a battery used to power the computer system 1000 or one or more of its components. The power device 1018 may provide one or more interfaces to provide an indication of a power level, a time window remaining prior to shutdown of computer system 1000 or one or more of its components, a power consumption rate, an indicator of whether computer system is utilizing an external power source or battery power, and other power related information. In some embodiments, indications related to the power device 1018 may be accessible remotely (e.g., accessible to a remote back-up management module via a network connection). In some embodiments, a battery utilized by the power device 1018 may be an uninterruptable power supply (UPS) local to or remote from computer system 1000. In such embodiments, the power device 1018 may provide information about a power level of the UPS.

The data storage device 1020 may include a computer-readable storage medium 1024 on which is stored one or more sets of instructions 1026 (e.g., software) embodying any one or more of the methodologies or functions described herein. The instructions 1026 may also reside, completely or at least partially, within the main memory 1004 and/or within the processor 1002 during execution thereof by the computer system 1000, the main memory 1004 and the processor 1002 also constituting computer-readable storage media. The instructions 1026 may further be transmitted or received over a network 1030 (e.g., the network 105) via the network interface device 1008.

In one embodiment, the instructions 1026 include instructions for one or more data analysis components 160 (or alternatively/additionally tracking components 170), which may correspond to the identically-named counterpart described with respect to FIG. 1. While the computer-readable storage medium 1024 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “receiving”, “retrieving”, “transmitting”, “computing”, “generating”, “adding”, “subtracting”, “multiplying”, “dividing”, “optimizing”, “calibrating”, “detecting”, “performing”, “analyzing”, “determining”, “enabling”, “identifying”, “modifying”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

The present disclosure is not to be limited in scope by the specific embodiments described herein. Indeed, other various embodiments of and modifications to the present disclosure pertaining to evaluating user sentiment, in addition to those described herein, will be apparent to those of ordinary skill in the art from the preceding description and accompanying drawings. Thus, such other embodiments and modifications pertaining to evaluating user sentiment are intended to fall within the scope of the present disclosure. Further, although the present disclosure has been described herein in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A method comprising:
transmitting, by a processing device of a user device, an indication to a server that an advertisement is to be presented by the user device;
receiving, by the processing device, data descriptive of the advertisement to be presented;
causing, by the processing device, the advertisement to be displayed in a graphical user interface simultaneously with a plurality of non-alphanumeric sentiment indicators, each of the non-alphanumeric sentiment indicators being indicative of user sentiment;
receiving, by the processing device, a user reaction to the advertisement, the user reaction comprising a selection of one of the plurality of non-alphanumeric sentiment indicators, the advertisement, or an option to dismiss the advertisement; and
responsive to receiving the user reaction, transmitting, by the processing device, an indication of the user reaction to the server.

2. The method of claim 1, further comprising:
responsive to receiving a selection of a non-alphanumeric sentiment indicator, causing, by the processing device, the advertisement to be dismissed from the graphical user interface.

3. The method of claim 1, further comprising:
responsive to receiving a selection of a non-alphanumeric sentiment indicator, causing, by the processing device, the graphical user interface to display additional content associated with the advertisement.

4. The method of claim 1, further comprising:
responsive to receiving a selection of a non-alphanumeric sentiment indicator, causing, by the processing device, the graphical user interface to display additional options while the advertisement is displayed, wherein the additional options comprise a first selectable option to receive additional content associated with the advertisement and a second selectable option to dismiss the advertisement.

5. The method of claim 1, further comprising:
responsive to determining that a selected non-alphanumeric sentiment indicator is indicative of positive sentiment, causing, by the processing device, the graphical user interface to display additional content associated with the advertisement; and
responsive to determining that the selected non-alphanumeric sentiment indicator is indicative of neutral or negative sentiment, causing, by the processing device, the advertisement to be dismissed from the graphical user interface.

6. The method of claim 1, wherein the plurality of non-alphanumeric sentiment indicators are displayed for a pre-defined time duration.

7. The method of claim 1, wherein each of the plurality of non-alphanumeric sentiment indicators comprise emojis.

8. The method of claim 7, wherein each emoji is a pictographic representation of an emotional or cognitive state.

9. The method of claim 1, wherein the advertisement comprises a video, one or more images, audio, text, or a combination thereof that is displayed in the graphical user interface as an overlay over other content, as part of the content, or adjacent to the content.

10. The method of claim 1, wherein each of the plurality of non-alphanumeric sentiment indicators is associated with a counter, each counter corresponding a number of times, computed by the server, that other users have selected the associated non-alphanumeric sentiment indicator, wherein the user interface further displays an associated counter adjacent to each of the plurality of non-alphanumeric sentiment indicators.

11. A system comprising:
a memory; and
a processing device operatively coupled to the memory, wherein the processing device is to:
transmit an indication to a server that an advertisement is to be presented in a graphical user interface;
receive data descriptive of the advertisement to be presented;
cause the advertisement to be displayed in the graphical user interface simultaneously with a plurality of non-alphanumeric sentiment indicators, each of the non-alphanumeric sentiment indicators being indicative of user sentiment;
receive a user reaction to the advertisement, the user reaction comprising a selection of one of the plurality of non-alphanumeric sentiment indicators, the advertisement, or an option to dismiss the advertisement; and
responsive to receiving the user reaction, transmit an indication of the user reaction to the server.

12. The system of claim 11, wherein the processing device is further to:
responsive to receiving a selection of a non-alphanumeric sentiment indicator, cause the advertisement to be dismissed from the graphical user interface.

13. The system of claim 11, wherein the processing device is further to:
responsive to receiving a selection of a non-alphanumeric sentiment indicator, cause the graphical user interface to display additional content associated with the advertisement.

14. The system of claim 11, wherein the processing device is further to:
responsive to receiving a selection of a non-alphanumeric sentiment indicator, cause the graphical user interface to display additional options while the advertisement is displayed, wherein the additional options comprise a first selectable option to receive additional content associated with the advertisement and a second selectable option to dismiss the advertisement.

15. The system of claim 11, wherein the processing device is further to:
responsive to determining that a selected non-alphanumeric sentiment indicator is indicative of positive sentiment, cause the graphical user interface to display additional content associated with the advertisement; and
responsive to determining that the selected non-alphanumeric sentiment indicator is indicative of neutral or negative sentiment, cause the advertisement to be dismissed from the graphical user interface.

16. The system of claim 11, wherein the plurality of non-alphanumeric sentiment indicators are to be displayed for a pre-defined time duration.

17. The system of claim 11, wherein each of the plurality of non-alphanumeric sentiment indicators comprise emojis, wherein each emoji is a pictographic representation of an emotional or cognitive state.

18. The system of claim 11, wherein the advertisement comprises a video, one or more images, audio, text, or a combination thereof that is to be displayed in the graphical user interface as an overlay over other content, as part of the content, or adjacent to the content.

19. The system of claim 11, wherein each of the plurality of non-alphanumeric sentiment indicators is associated with a counter, each counter corresponding a number of times, computed by the server, that other users have selected the associated non-alphanumeric sentiment indicator, wherein the user interface is to further display an associated counter adjacent to each of the plurality of non-alphanumeric sentiment indicators.

20. A method comprising:
receiving, by a processing device, an indication that an advertisement is to be presented by a user device;
receiving, by the processing device, data descriptive of the advertisement from a content server;
transmitting, to the user device, the data descriptive of the advertisement and an executable resource, wherein the executable resource, when executed by the user device, causes a graphical user interface of the user device to display the advertisement simultaneously with a plurality of non-alphanumeric sentiment indicators, each of the non-alphanumeric sentiment indicators being indicative of user sentiment;
receiving, by the processing device, an indication of a user reaction to the advertisement, the user reaction comprising a selection of one of the plurality of non-alphanumeric sentiment indicators, the advertisement, or an option to dismiss the advertisement; and
associating the indication with the advertisement.

21. The method of claim 20, further comprising:
deriving, by the processing device, an emotional or cognitive measure from sentiment data associated with the advertisement, the sentiment data comprising the received indication.
